(19) United States
(12) Patent Application Publication
(10) Pub. No.: US 2013/0233186 A1
(43) Pub. Date: Sep. 12, 2013

(54) BOTTLE COMPACTION SYSTEM AND METHOD

(71) Applicant: Yann Morez, Englewood, CO (US)

(72) Inventor: Yann Morez, Englewood, CO (US)

(21) Appl. No.: 13/727,749

(22) Filed: Dec. 27, 2012

Related U.S. Application Data
(60) Provisional application No. 61/609,236, filed on Mar. 9, 2012.

(51) Int. Cl. B30B 12/00

(52) U.S. Cl. CPC B30B 12/00
USPC 100/73

(57) ABSTRACT

Systems and methods of compressing a bottle is disclosed. An example system includes a housing, gas port, and a movable platen. A compressible bottle may be mounted within the housing such that the bottle opening is in fluid communication with the gas port and such that the bottle is located between the gas port and the movable platen. A flow of a gas is provided through the gas port into the compressible bottle through the bottle opening. The movable platen is driven toward the gas port after beginning a flow of gas into the bottle, causing the compressible bottle to collapse substantially along the bottle length.

### PRIORITY CLAIM

This application claims priority to U.S. Provisional Patent Application No. 61/609,236 titled “Plastic Bottle Compressor” of Yann Morez filed on Mar. 9, 2012, which is hereby incorporated by reference as though fully set forth herein.

### BACKGROUND

Bottles, such as those made from a recyclable plastic material, such as but not limited to polyethylene terephthalate (PET) and high-density polyethylene plastics (HDPE), are commonly employed in our society. These bottles are used, for example, to contain any of a wide variety of liquids ranging from bottled water and soft drinks for human consumption to various cleaning products. One drawback of such bottles is that, once emptied and ready for disposal, the empty bottles can occupy a significant amount of space, for example, in a trash or recycling container. The space needed to store empty bottles is particularly acute when one considers the storage space relative to the actual amount of plastic associated with a given bottle. That is, the volume of storage space is very large compared to the volume of plastic being stored, resulting in a high storage volume to recyclable material ratio.

### BRIEF DESCRIPTION OF THE DRAWINGS

FIG. 1a is a perspective view of an example bottle compression system.

FIG. 1b illustrates an isometric, partially schematic view of the example bottle compression system shown in FIG. 1a.

FIG. 2 shows a front cross-sectional view of the example bottle compression system with a compressible bottle therein, prior to compression of the compressible bottle.

FIG. 3 is a front cross-sectional view of the example bottle compression system shown in FIG. 2, upon compression of the compressible bottle.

FIG. 4 is an isometric view of another example bottle compression system, without a compressible bottle therein.

### DETAILED DESCRIPTION

The systems and methods described herein reduce the amount of space (or volume) occupied by an empty compressible bottle in a trash or recycling container. In an example, the systems and methods collapse, at least partially, the bottles prior to disposing of such bottles.

People may squeeze bottles using their hands (in a direction that is parallel to the length of a central axis of the bottle) to remove some of the air and thus partially collapse bottles. However, the partially collapsed compressible bottle still takes up a relatively large amount of space in a trash or recycling container because only the diameter of the bottle has been reduced. Further complicating matters is the reduction only reduces the midsection of the bottle, with the top and bottom tending to retain their initial respective shapes (and thus volume). As a result, a compressible bottle crushed in that manner stills occupy a fairly large amount of space in a trash or recycling container.

The systems and methods described herein promote efficient collapse of compressible bottles in a manner that greatly minimizes the volume occupied in a recycling or refuse container. Additionally, this collapse can be accomplished in just a matter of a few seconds.

In an example, a compressible bottle compaction system includes a housing, a gas port, a source of gas, and a movable platen. The housing is configured to receive a compressible bottle therein, with the compressible bottle defining an opening end. The gas port is defined within the housing, and the gas port is configured for engaging the opening end of the compressible bottle. The source of a gas is selectably communicable with the gas port. The movable platen is associated with the housing, with the movable platen being movable toward and away from the gas port. Further, the movable platen is capable of being initially positioned within the housing so as to permit receipt of the compressible bottle within the housing between the gas port and the movable platen.

In another example, a method of compressing a compressible bottle is provided. The compressible bottle has a bottle opening and a bottle length. A housing and a gas port and a movable platen associated with the housing is provided. During operation, the compressible bottle may be positioned at least partially within the housing such that the bottle opening is in fluid communication with the gas port, and such that the bottle is located between the gas port and the movable platen. A flow of a gas (e.g., heated or hot gas) is provided through the gas port into the compressible bottle through the bottle opening. The movable platen is driven toward the gas port after beginning a flow of gas into the bottle, causing the compressible bottle to partially or even fully collapse substantially along the bottle length (along a central axis of the bottle).

Before continuing, it is noted that as used herein, the terms “includes” and “including” mean, but is not limited to, “includes” or “including” and “includes at least” or “including at least.” The term “based on” means “based on” and “based at least in part on.”

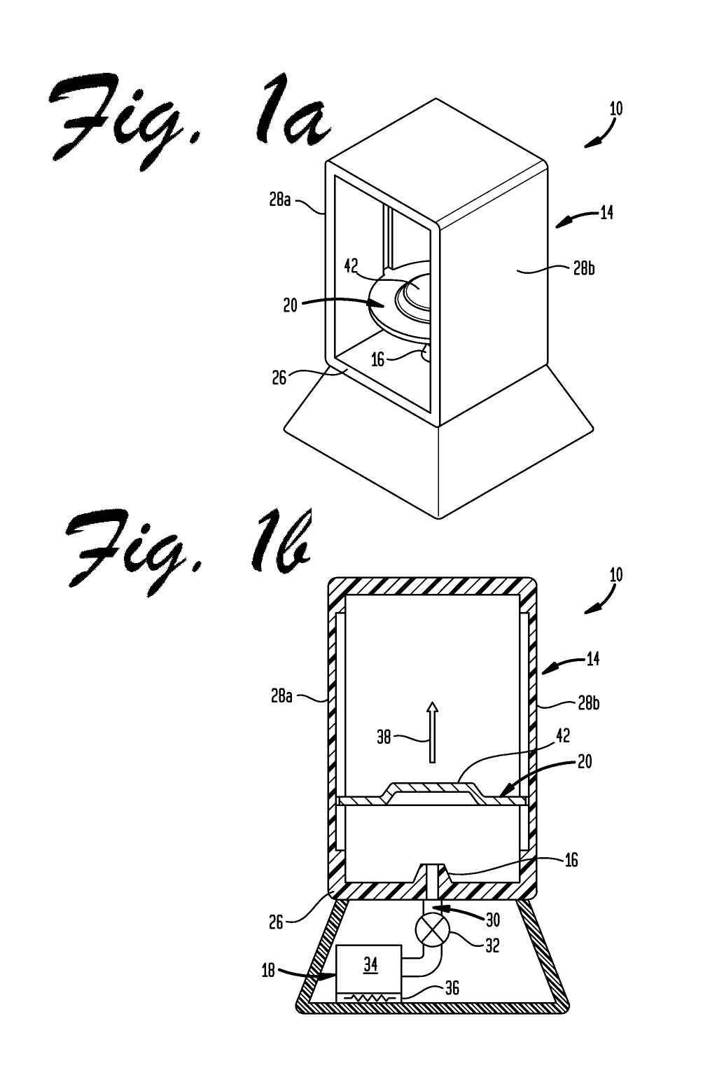

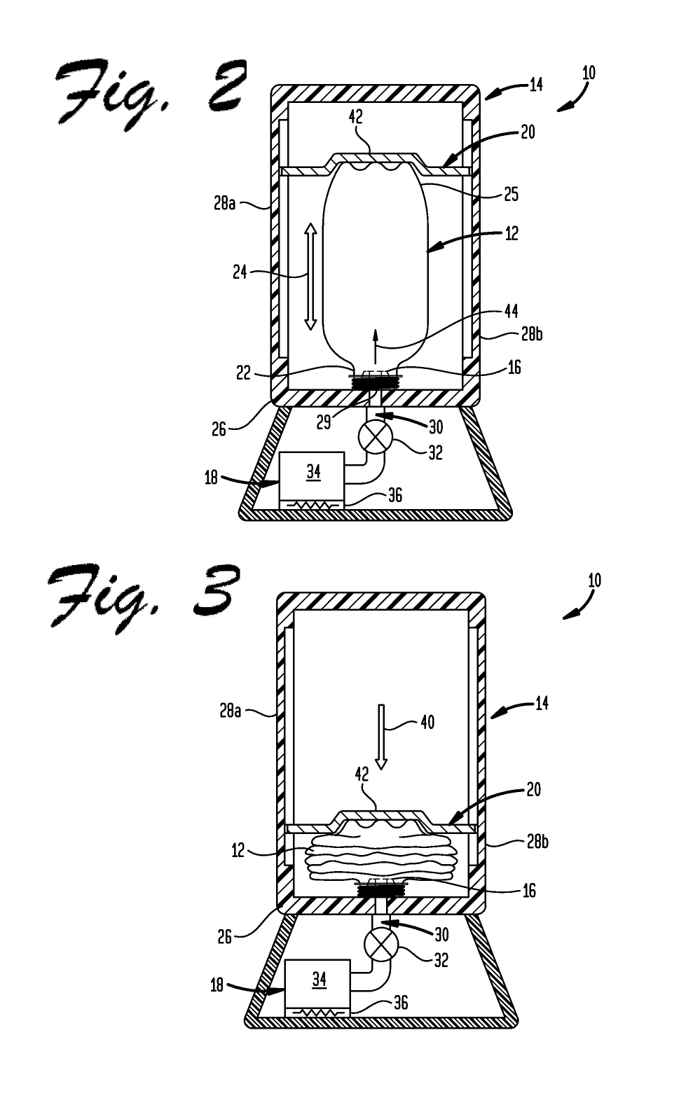

FIG. 1a is a perspective view of an example bottle compression system. FIG. 1b illustrates an isometric, partially schematic view of the example bottle compression system shown in FIG. 1a. The example bottle compression system 10 may be operated for compacting, crushing, or otherwise collapsing a compressible bottle 12 (e.g., as illustrated in FIG. 2). In the illustrated version, the bottle compression system 10 is a small household appliance for crushing/compacting one bottle 12 at a time. However, it is to be understood that the system may be sized and configured for use with a plurality of compressible bottles 12 that can be simultaneously compacted (including, but not limited to, on an industrial scale).

In an example, the bottle compression system 10 includes a housing 14, a gas port 16, a gas source 18 (e.g., gas), and a movable platen 20. The housing 14 is configured to receive the compressible bottle 12 therein, with the compressible bottle 12 defining an opening end 22, a bottle length 24 (schematically indicated in FIG. 2), and a bottle base 25. The housing 14 includes at least a housing base 26 and two opposing housing walls or sides 28a-b. The two housing walls 28a-b respectively extend substantially orthogonally from the same side and abut opposing edges of the housing base 26 (the side and edges not being labeled).

The gas port 16 is defined within the housing 14, and the gas port 16 is configured for engaging the opening end 22 of the compressible bottle 12. The gas port 16 is supplied with at least one port channel 29 that can serve as a gas pathway into the compressible bottle 12. In an example, the housing base 26 includes the gas port 16, with an opening of the gas port 16 extending therefrom to facilitate engagement with the opening end 22 of the compressible bottle 12. In another example, the gas port 16 may take the form of a receiving bore (not shown) within the housing base 26.

In either example, the gas port 16 may be sized (e.g., height, depth, and/or diameter) so as to facilitate stable positioning of the compressible bottle 12 within the housing 14 for the compression cycle. The gas port 16 may also allow gas escape from the compressible bottle 12 during the compression cycle so as not to create a complete seal with the compressible bottle 12, or if a seal is formed, provide a gas exhaust path.

The gas port 16 is shown in the Figures having a frustro-conical shape, allowing the gas port 16 to engage a wide range of bottles (e.g., having different opening end diameters). It is understood, however, that other gas port shapes are also possible, including but not limited to a shape (not shown) which defines at least one inlet flow path and at least one exhaust flow path to enable gas flow both into and out of a given compressible bottle 12.

The gas source 18 is selectably communicable with the gas port 16 via a piping or tubing 30. The gas source 18 may be made selectably communicable with the gas port 16 (e.g., via presence of a valve 34 within the piping 30). The gas source 18 includes both a fluid tank or vessel 34 and a tank heater 36. The fluid tank 34 may carry a gas and/or a readily evaporable liquid. In an example, the fluid tank carries water. The water can be converted to steam for delivery to the compressible bottle 12.

The fluid tank 34 may have a re-sealable stopper or plug (not shown) or other similar mechanism to allow refilling of the fluid tank 34, while preventing unwanted gas escape at other times.

The tank heater 36 (e.g., an electrical resistance-based, or other type of heating element) is configured to heat the fluid in the fluid tank 34 to an appropriate temperature. For example, a temperature capable of mollifying the plastic material from which the compressible bottle 12 is made and/or to promote evaporation and/or boiling of a liquid contained in the fluid tank 34 (e.g., water into steam).

For purposes of illustration, a gas (or the gas being generated within the fluid tank 34) is heated to a temperature above room temperature but below the melting temperature of the compressible bottle 12 (e.g., the melting temperature of PET being about 250 C-260 C). For example, the gas may be heated to a temperature in the range of about 50° C. to about 150° C. When steam is to be used as the gas, the temperature may be in the range of about 70° C. to about 100° C.

In an example, design parameters for temperature of the gas to be delivered through the gas port 16 include, but are not limited to the temperature being sufficiently high to reduce pressure inside the compressible bottle 12 relative to the surrounding air pressure, enough to ease the compression/collapse thereof and yet to be low enough so as to not promote melting or decomposition of the plastic.

In another example, design parameters for temperature of the gas to be delivered through the gas port 16 include, but are not limited to the temperature being sufficiently high to help mollify and/or structurally weaken the plastic of the compressible bottle 12 enough to ease the compression/collapse thereof and yet to be low enough so as to not promote melting or decomposition of the plastic.

In either example, the temperature/exposure time combination should, beneficially, be such that a given compressible bottle 12 could still be handled by a user shortly upon completion of the compression cycle.

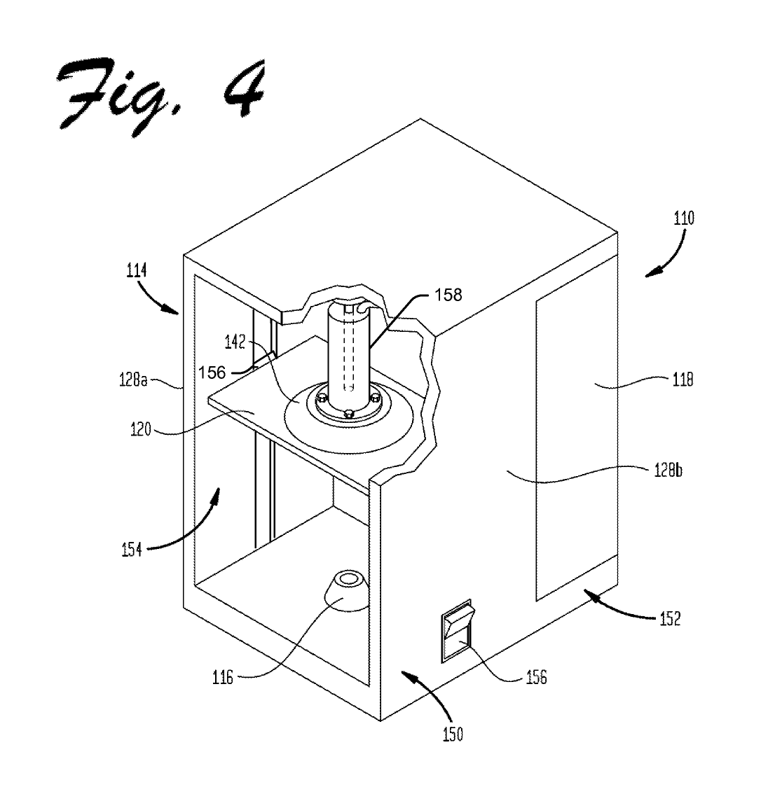

FIG. 2 shows a front cross-sectional view of the example bottle compression system 10 with a compressible bottle 12 therein, prior to compression of the compressible bottle 12. FIG. 3 is a front cross-sectional view of the example bottle compression system 10 shown in FIG. 2, upon compression of the compressible bottle 12.

With reference to FIG. 2, the positioning of the movable platen 20 within the bottle compression system 10 can be seen in a manner so as to receive the compressible bottle 12, in its original, full-size form. The movable platen 20 is associated with the housing 14, with the movable platen 20 being movable in a first or loading/unloading direction 38 away from the gas port 16 (i.e., allowing insertion/removal of a given compressible bottle 12).

With reference to FIG. 3, a second or compression direction 40 is illustrated as the movable platen moves toward the gas port 16. The movable platen 20 may, for example, be slidably mounted between the housing sides 28a-b or separately aligned therebetween.

It is understood that the movable platen 20 can be moved manually (or driven automatically) by a pushing and/or a pulling action. For example, the user may use his or her foot to manually move the platent 20. Or for example, the platen 20 may be driven via a motor (not shown).

As shown in FIG. 2, the movable platen 20 can be initially positioned within the housing 14 so as to permit receipt of the compressible bottle 12 within the housing 14, between the gas port 16 and the movable platen 20. Further, the movable platen 20 may be provided with a bottle end receiving concavity 42 for receipt of the bottle end 25 and thereby be able help to maintain alignment of the compressible bottle 12 during the compression cycle.

FIGS. 2 and 3 together illustrate a compression operation cycle using the bottle compression system 10. In an example, the compressible bottle 12 is mounted within the housing 14 such that the opening end 22 of the compressible bottle 12 is in fluid communication with the gas port 16. The compressible bottle 12 is located between the gas port 16 and the movable platen 20.

A gas flow 44 is introduced through the gas port 16 into the compressible bottle 12 through the opening end 22 thereof, before moving the movable platen 20 in the second or compression direction 40. After beginning the gas flow 44 into the compressible bottle 12, the movable platen 20 is driven toward the gas port 16 with enough force to cause the compressible bottle 12 to collapse substantially along the bottle length 24.

It is noted that the driving force to cause such collapse could be manually provided or that force could be generated by a motor (not shown), with the latter scenario being particularly useful if an automated and/or mass quantity crushing system were to be employed. Once the compressible bottle 12 is compressed or compacted, the movable platen 20 can be translated in the first direction 38 to facilitate removal of the now compressed compressible bottle 12 (step not illustrated).

FIG. 4 is an isometric view of another example bottle compression system 110, without a compressible bottle therein. It is noted that similarly numbered parts (e.g., gas port 16, 116) are to be considered similar in construction and functionality unless otherwise described. Therefore, the description of each component may not be repeated in full again with reference to FIG. 4.

In this example, the bottle compression system 110 includes a housing 114, a gas port 116, a gas source 118, and a movable platen 120. The bottle compression system 110 is designed to be a kitchen countertop appliance. The housing 114 differs from housing 14 in that it has a front housing portion 150 in which the compression cycle is to be performed. A rear housing portion 152 is designed to carry the gas source 118. Further, the front housing portion 150 includes a pair of opposing housing walls or sides 128a-b, and those housing walls 128a-b are provided with a respective slide track 156 to facilitate the slide mounting of the movable platen 120 within the front housing portion 150. In the example shown, the movable platen 120 is further provided with a bottle end receiving concavity 142 operable by a pneumatic cylinder to automatically compress a bottle in the compression chamber.

The bottle compression system 110, in the illustrated embodiment, is also provided with an on/off switch 156 that is able to control the gas flow 144 through the gas port 116. In particular, the on/off switch 156 may activate a valve similar to the valve 32 and/or a heater similar to the tank heater 36 to permit a selected gas flow 144 to occur.

It is understood that other controls and/or gauges (not shown), such as a thermal regulator and/or thermometer for the tank heater 36 or an electronic flow control may also be provided as part of the system. Such controls and/or gauges are deemed to be within the scope of the present disclosure and can be readily implemented by those having ordinary skill in the art after becoming familiar with the disclosure herein.

It is also contemplated that a drive motor and related controls (neither shown) may be provided to automate the movement of the movable platen 20, 120 and to permit adjustment of the force applied to a given compressible bottle 12. Again, drive motors and related controls are deemed to be within the scope of the present disclosure and can be readily implemented by those having ordinary skill in the art after becoming familiar with the disclosure herein.

It is noted that the examples shown and described are provided for purposes of illustration and are not intended to be limiting. Still other examples are also contemplated.

1. A compressible bottle compaction system comprising:
a housing in which to receive a compressible bottle, the compressible bottle having an opening end;
a gas port in the housing, the gas port configured to fluidically connect with the opening end of the compressible bottle and provide a gas flow path into the compressible bottle; and
a movable platen associated with the housing, the movable platen being movable toward and away from the gas port, the movable platen initially positioned within the housing to permit receipt of the compressible bottle within the housing between the gas port and the movable platen, the movable platen moving toward the gas port to compress the compressible bottle after at least some gas flows into the compressible bottle.

2. The system of claim 1 wherein the gas port extends from the housing, the gas port having at least one of a sufficient height and diameter to help stably position the compressible bottle within the housing.

3. The system of claim 1 further comprising a source of the gas, wherein the gas is provided at a temperature capable of mollifying a plastic material from which the compressible bottle is made.

4. The system of claim 3 wherein the gas is steam.

5. The system of claim 3 wherein the source of the gas includes a container of water and a source of heat for converting at least a portion of the water to steam.

6. The system of claim 1 wherein the movable platen is movable toward the gas port with a force such that when the compressible bottle is in place within the housing and the gas has been delivered into the compressible bottle, the compressible bottle is collapsed substantially along a central axis of the compressible bottle.

7. The system of claim 1 wherein the movable platen is manually movable toward the gas port.

8. The system of claim 1 wherein the movable platen further defines a bottle end receiving concavity configured to maintain alignment of the compressible bottle during a compression cycle.

9. The system of claim 1 wherein the compressible bottle compaction system is a household countertop system.

10. The system of claim 1 wherein a controller controls a flow of the gas through the gas port.

11. A method of compressing a compressible bottle, the compressible bottle having a bottle opening and a bottle length extending between a base portion and a top portion, the method comprising:
defining a housing and a gas port and a movable platen associated with the housing;
receiving the compressible bottle within the housing such that the bottle opening is in fluid communication with the gas port and such that the bottle is located along the bottle length between the gas port and the movable platen;
providing a gas path through the gas port into the compressible bottle through the bottle opening; and
driving the movable platen toward the gas port after beginning a flow of gas into the bottle, causing the compressible bottle to structurally collapse substantially along the bottle length.

12. The method of claim 11, wherein the gas is at a temperature sufficient to mollify a material from which the compressible bottle is made.

13. The method of claim 12, wherein the gas is above room temperature but below the melting point of the material.

14. The method of claim 13, wherein the gas is at a temperature in the range of about 70° C. to about 115° C.

15. The method of claim 11, wherein the gas is at a temperature to reduce pressure within the bottle relative to a pressure surrounding the compressible bottle.

16. The method of claim 11, further comprising maintaining an alignment of the compressible bottle within the housing and to permit gas flow out of the compressible bottle during collapse.

17. The method of claim 11, wherein the movable platen is driven by at least one of a pushing action and a pulling action.

18. A system of compressing a bottle, the bottle having a bottle opening and a bottle length extending between a base portion and a top portion, the system comprising:
a housing and a gas port and a movable platen associated with the housing;
means for receiving the bottle within the housing such that the bottle opening is in fluid communication with the gas port and such that the bottle is located along the bottle length between the gas port and the movable platen;
means for providing a gas path through the gas port into the compressible bottle through the bottle opening; and
means for driving the movable platen toward the gas port after beginning a flow of gas into the bottle, causing the compressible bottle to structurally collapse substantially along the bottle length.

19. The system of claim 18, wherein the gas is at a temperature selected to mollify outer walls of the bottle.

20. The system of claim 18, wherein the gas is at a temperature to reduce pressure within the bottle relative to a pressure surrounding the compressible bottle, so that a pressure differential is generated to assist in collapsing the bottle.
